(19) United States
(12) Patent Application Publication
(10) Pub. No.: US 2025/0039478 A1
(43) Pub. Date: Jan. 30, 2025

(54) SUPPORT OF SUBSEGMENTS BASED STREAMING OPERATIONS IN EDRAP BASED VIDEO STREAMING

(71) Applicant: Bytedance Inc., Los Angeles, CA (US)

(72) Inventor: Ye-Kui Wang, San Diego, CA (US)

(21) Appl. No.: 18/914,663

(22) Filed: Oct. 14, 2024

Related U.S. Application Data
(63) Continuation of application No. PCT/US2023/018354, filed on Apr. 12, 2023.
(60) Provisional application No. 63/330,210, filed on Apr. 12, 2022.

(51) Int. Cl. H04N 21/2343; H04N 21/4402

(52) U.S. Cl. CPC H04N 21/2343; H04N 21/4402

(57) ABSTRACT

A mechanism for processing video data is disclosed. A conversion is performed between a visual media data and a media data file based on one or more extended dependent random access point (EDRAP) samples. Each EDRAP sample shall be a first sample in segment or a subsegment of a main stream representation (MSR).

### CROSS REFERENCE TO RELATED APPLICATIONS

This application is a continuation of International Patent Application No. PCT/US2023/018354, filed on Apr. 12, 2023, which claims the priority to and benefits of U.S. Provisional Application No. 63/330,210, which was filed on Apr. 12, 2022. All the aforementioned patent applications are hereby incorporated by reference in their entireties.

### TECHNICAL FIELD

This patent document relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: performing a conversion between a visual media data and the media data file based on one or more extended dependent random access point (EDRAP) samples, wherein each EDRAP sample shall be a first sample in segment or a subsegment of a main stream representation (MSR).

A second aspect relates to an apparatus for processing video data comprising a processor; and a non-transitory memory with instructions thereon, wherein the instructions upon execution by the processor, cause the processor to perform any of the preceding aspects.

A third aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises determining to perform a conversion between a visual media data and a media data file based on one or more extended dependent random access point (EDRAP) samples, wherein each EDRAP sample shall be a first sample in segment or a subsegment of a main stream representation (MSR); and generating a bitstream based on the determining.

A fifth aspect relates to a method for storing bitstream of a video comprising determining to perform a conversion between a visual media data and a media data file based on one or more extended dependent random access point (EDRAP) samples, wherein each EDRAP sample shall be a first sample in segment or a subsegment of a main stream representation (MSR); generating a bitstream based on the determining; and storing the bitstream in a non-transitory computer-readable recording medium.

An sixth aspect relates to a method, apparatus or system described in the present document.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example mechanism for random access when decoding a bitstream using intra random access point (IRAP) pictures.

FIG. 2 is a schematic diagram of an example mechanism for random access when decoding a bitstream using Dependent random access point (DRAP) pictures.

FIG. 3 is a schematic diagram of an example mechanism for random access when decoding a bitstream using extended dependent random access point (EDRAP) pictures.

FIG. 4 is a schematic diagram of an example mechanism for signaling an external bitstream to support EDRAP based random access.

FIG. 5 illustrates an example of EDRAP based random access.

FIG. 6 is a block diagram showing an example video processing system.

FIG. 7 is a block diagram of an example video processing apparatus.

FIG. 8 is a flowchart for an example method of video processing.

FIG. 9 is a block diagram that illustrates an example video coding system.

FIG. 10 is a block diagram that illustrates an example encoder.

FIG. 11 is a block diagram that illustrates an example decoder.

FIG. 12 is a schematic diagram of an example encoder.

FIG. 13 is a flowchart for an example method of video processing.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present document for case of understanding and do not limit the applicability of techniques and embodiments disclosed in each section only to that section. Furthermore, H.266 terminology is used in some description only for ease of understanding and not for limiting scope of the disclosed techniques. As such, the techniques described herein are applicable to other video codec protocols and designs also. In the present document, editing changes are shown to text by bold italics indicating cancelled text and bold underline indicating added text, with respect to a draft of the Versatile Video Coding (VVC) specification or ISO base media file format (ISOBMFF) file format specification.

### 1. INITIAL DISCUSSION

This document is related to video streaming. Specifically, it is related to the support of subsegments based streaming operations in extended dependent random access point (EDRAP) based video streaming. EDRAP based streaming involve the use of main stream representations (MSRs) and external stream representations (ESRs) in Dynamic Adaptive Streaming over Hypertext transfer protocol (DASH). The ideas may be applied individually or in various combinations, for media streaming systems, e.g., based on the DASH standard or its extensions.

### 2. VIDEO CODING INTRODUCTION

### 2.1 Video Coding Standards

Video coding standards have evolved primarily through the development of the International Telecommunication Union-Telecommunication Standardization Sector (ITU-T) and International Organization for Standardization (ISO)/International Electrotechnical Commission (IEC) standards. The ITU-T produced H.261 and H.263, ISO/IEC produced Moving Picture Experts Group (MPEG)-1 and MPEG-4 Visual, and the two organizations jointly produced the H.262/MPEG-2 Video and H.264/MPEG-4 Advanced Video Coding (AVC) and H.265/High Efficiency Video Coding (HEVC) [1] standards. Since H.262, the video coding standards are based on the hybrid video coding structure wherein temporal prediction plus transform coding are utilized. To explore the future video coding technologies beyond HEVC, the Joint Video Exploration Team (JVET) was founded by Video Coding Experts Group (VCEG) and MPEG jointly in 2015. Many methods have been adopted by JVET and put into the reference software named Joint Exploration Model (JEM) [2]. The JVET was renamed to be the Joint Video Experts Team (JVET) when the Versatile Video Coding (VVC) project officially started. VVC [3] is a coding standard, targeting at 50% bitrate reduction as compared to HEVC.

The Versatile Video Coding (VVC) standard (ITU-T H.266|ISO/IEC 23090-3) [3][4] and the associated Versatile Supplemental Enhancement Information (VSEI) standard (ITU-T H.274|ISO/IEC 23002-7) [5][6] is designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard developed by MPEG.

### 2.2 File Format Standards

Media streaming applications are based on the Internet Protocol (IP), Transmission Control Protocol (TCP), and Hypertext Transfer Protocol (HTTP) transport methods, and rely on a file format such as the ISO base media file format (ISOBMFF) [7]. One such streaming system is dynamic adaptive streaming over HTTP (DASH) [8]. For using a video format with ISOBMFF and DASH, a file format specification specific to the video format, such as the AVC file format and the HEVC file format in [9], would be needed for encapsulation of the video content in ISOBMFF tracks and in DASH representations and segments. Important information about the video bitstreams, e.g., the profile, tier, and level, and many others, would need to be exposed as file format level metadata and/or DASH media presentation description (MPD) for content selection purposes, e.g., for selection of appropriate media segments both for initialization at the beginning of a streaming session and for stream adaptation during the streaming session.

Similarly, for using an image format with ISOBMFF, a file format specification specific to the image format, such as the AVC image file format and the HEVC image file format in [10], would be needed.

The VVC video file format, the file format for storage of VVC video content based on ISOBMFF, is under development by MPEG. A draft specification of the VVC video file format is included in [11].

The VVC image file format, the file format for storage of image content coded using VVC, based on ISOBMFF, is under development by MPEG. A draft specification of the VVC image file format is included in [12].

### 2.3 DASH

In Dynamic adaptive streaming over HTTP (DASH) [8], there may be multiple representations for video and/or audio data of multimedia content, different representations may correspond to different coding characteristics (e.g., different profiles or levels of a video coding standard, different bitrates, different spatial resolutions, etc.). The manifest of such representations may be defined in a Media Presentation Description (MPD) data structure. A media presentation may correspond to a structured collection of data that is accessible to DASH streaming client device. The DASH streaming client device may request and download media data information to present a streaming service to a user of the client device. A media presentation may be described in the MPD data structure, which may include updates of the MPD.

A media presentation may contain a sequence of one or more periods. Each period may extend until the start of the next Period, or until the end of the media presentation, in the case of the last period. Each period may contain one or more representations for the same media content. A representation may be one of a number of alternative encoded versions of audio, video, timed text, or other such data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

AN example DASH streaming procedure is shown by the following steps:
1) The client gets the MPD.
2) The client estimates the downlink bandwidth, and selects a video representation and an audio representation according to the estimated downlink bandwidth and the codec, decoding capability, display size, audio language setting, etc.
3) Unless the end of the media presentation is reached, the client requests media segments of the selected representations and presents the streaming content to the user.
4) The client keeps estimating the downlink bandwidth. When the bandwidth changes to a direction (e.g., becomes lower) significantly, the client selects a different video representation to match the newly estimated bandwidth, and go to step 3.

### 2.4 DASH Segments and Subsegments

In DASH, a Segment is a unit of data associated with an HTTP-URL and optionally a byte range that are specified by an MPD, or with a data URL. A Subsegment is a unit within a Segment that is indexed by a Segment Index. A Segment Index is compact index of the time range to byte range mapping within a Segment separately from the MPD.

Given the lengths of Segments, Subsegments based streaming operations allow for controlling the streaming process in a finer granularity through requesting media data in a finer granularity. For requesting Subsegments in a Segment, a Segment Index is requested beforehand to obtain information of the Subsegments and partial HTTP GET requests are used.

### 2.5 Extended Dependent Random Access Point (EDRAP) Based Video Coding, Storage, and Streaming

### 2.5.1 the Concept and the Standard Support

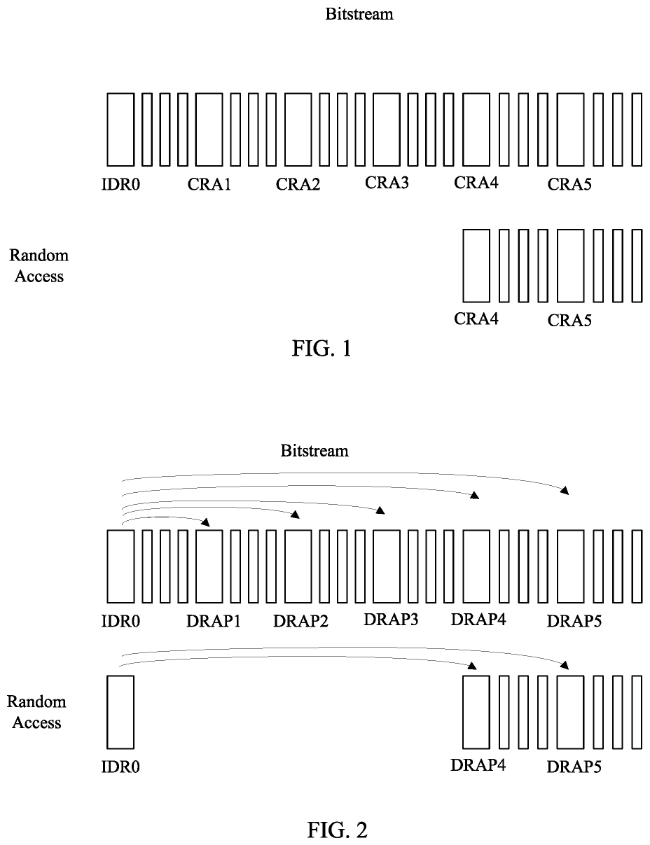

The concept of EDRAP based video coding, storage, and streaming is described herein. As shown in FIG. 1, the application (e.g., adaptive streaming) determines the frequency of random access points (RAPs), e.g., RAP period 1s or 2s. In an example, RAPs are provided by coding of IRAP pictures. Note that inter prediction references for the non-key pictures between RAP pictures are not shown, and from left to right is the output order. When random accessing from clean random access (CRA)4, the decoder receives and correctly decodes CRA4, CRA5, etc. and related inter predicted pictures.

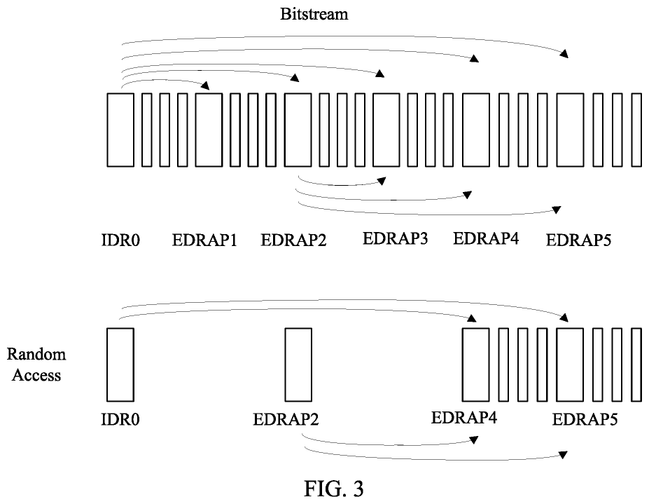

FIG. 2 illustrates the DRAP approach, which provides improved coding efficiency by allowing a DRAP picture (and subsequent pictures) to refer to the previous IRAP picture for inter prediction. Note that inter prediction for the non-key pictures between RAP pictures are not shown, and from left to right is the output order. When random accessing from DRAP4, the decoder receives and correctly decodes Instantaneous Decoder Refresh (IDR)0, DRAP4, DRAP5, etc. and related inter predicted pictures.

FIG. 3 illustrates the EDRAP approach, which provides a bit more flexibility by allowing an EDRAP picture (and subsequent pictures) to refer to a few of the earlier RAP pictures (IRAP or EDRAP). Note that inter prediction for the non-key pictures between RAP pictures are not shown, and from left to right is the output order. When random accessing from EDRAP4, the decoder receives and correctly decodes IDR0, EDRAP2, EDRAP4, EDRAP5, etc. and related inter predicted pictures.

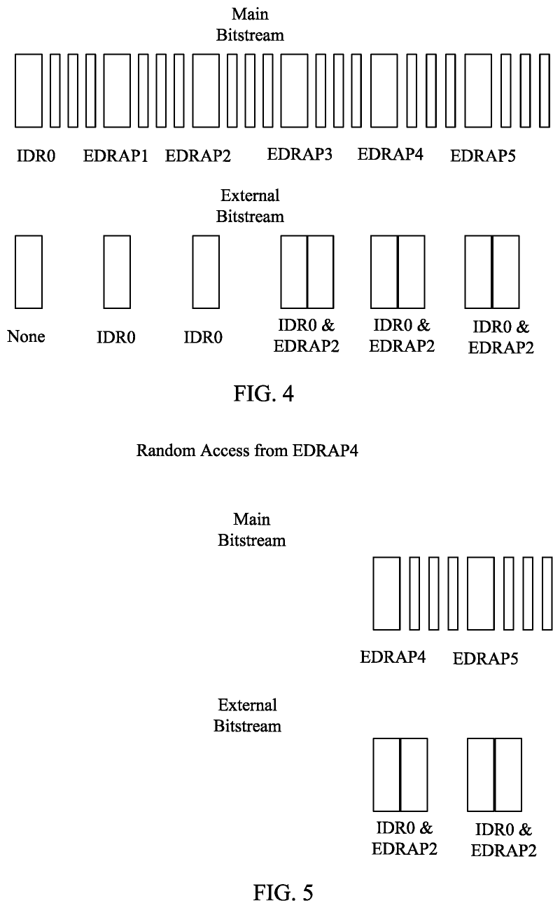

FIG. 4 illustrates an example of the EDRAP approach using MSR segments and ESR segments. FIG. 5 illustrates an example of random access from EDRAP4. When random accessing from or switching to the segment starting at EDRAP4, the decoder receives and decodes segments including IDR0, EDRAP2, EDRAP4, EDRAP5, etc. and related inter predicted pictures.

EDRAP based video coding is supported by the EDRAP indication SEI message included in [13], an amendment to the VSEI standard; the storage part is supported by the EDRAP sample group and the associated external stream track reference included in [14], an amendment to the ISOBMFF standard; and the streaming part is supported by the main stream representation (MSR) and external stream Representation (ESR) descriptors included in [15], an amendment to the DASH standard. These standard supports are described below.

### 2.5.2 the EDRAP Indication SEI Message

An amendment to the VSEI standard is under development. An example draft specification of this amendment is included in JVET-Y2006 [13], which includes the specification of the EDRAP indication SEI message.

The syntax and semantics of the EDRAP indication SEI message are as follows.

| | Descriptor |
|---|---|
| extended_drap_indication( payloadSize ) { | |
| edrap_rap_id_minus1 | u(16) |
| edrap_leading_pictures_decodable_flag | u(1) |
| edrap_reserved_zero_12bits | u(12) |
| edrap_num_ref_rap_pics_minus1 | u(3) |
| for( i = 0; i <= edrap_num_ref_rap_pics_minus1; i++ ) | |
| edrap_ref_rap_id[ i ] | u(16) |
| } | |

The picture associated with an extended DRAP (EDRAP) indication SEI message is referred to as an EDRAP picture.

The presence of the EDRAP indication SEI message indicates that the constraints on picture order and picture referencing specified in this subclause apply. These constraints can enable a decoder to properly decode the EDRAP picture and the pictures that are in the same layer and follow it in both decoding order and output order without needing to decode any other pictures in the same layer except the list of pictures referenceablePictures, which includes a list of IRAP or EDRAP pictures in decoding order that are within the same coded layer video sequence (CLVS) and identified by the edrap_ref_rap_id[i] syntax elements.

The constraints indicated by the presence of the EDRAP indication SEI message, which shall all apply, are as follows:
The EDRAP picture is a trailing picture.
The EDRAP picture has a temporal sublayer identifier equal to 0.
The EDRAP picture does not include any pictures in the same layer in the active entries of its reference picture lists except the referenceablePictures.
Any picture that is in the same layer and follows the EDRAP picture in both decoding order and output order does not include, in the active entries of its reference picture lists, any picture that is in the same layer and precedes the EDRAP picture in decoding order or output order, with the exception of the referenceablePictures.
Any picture in the list referenceablePictures does not include, in the active entries of its reference picture lists, any picture that is in the same layer and is not a picture at an earlier position in the list referenceablePictures.
NOTE—Consequently, the first picture in referenceablePictures, even when it is an EDRAP picture instead of an IRAP picture, does not include any picture from the same layer in the active entries of its reference picture lists.

edrap_rap_id_minus1 plus 1 specifies the RAP picture identifier, denoted as RapPicId, of the EDRAP picture.

Each IRAP or EDRAP picture is associated with a RapPicId value. The RapPicId value for an IRAP picture is inferred to be equal to 0. The RapPicId values for any two EDRAP pictures associated with the same IRAP picture shall be different.

edrap_leading_pictures_decodable_flag equal to 1 specifies that both of the following constraints apply:
Any picture that is in the same layer and follows the EDRAP picture in decoding order shall follow, in output order, any picture that is in the same layer and precedes the EDRAP picture in decoding order.
Any picture that is in the same layer and follows the EDRAP picture in decoding order and precedes the EDRAP picture in output order shall not include, in the active entries of its reference picture lists, any picture that is in the same layer and precedes the EDRAP picture in decoding order, with the exception of the referenceablePictures.

edrap_leading_pictures_decodable_flag equal to 0 does not impose such constraints.

edrap_reserved_zero_12bits shall be equal to 0 in bitstreams conforming to this version of this Specification. Other values for edrap_reserved_zero_12bits are reserved for use by ITU-T|ISO/IEC. Decoders shall ignore the value of edrap_reserved_zero_12bits.

edrap_num_ref_rap_pics_minus1 plus 1 indicates the number of IRAP or EDRAP pictures that are within the same CLVS as the EDRAP picture and may be included in the active entries of the reference picture lists of the EDRAP picture.

edrap_ref_rap_id[i] indicates RapPicId of the i-th RAP picture that may be included in the active entries of the reference picture lists of the EDRAP picture. The i-th RAP picture shall be either the IRAP picture associated with the current EDRAP picture or an EDRAP picture associated with the same IRAP picture as the current EDRAP picture.

### 2.5.3 the EDRAP Sample Group and Associated External Stream Track Reference

An amendment to the ISOBMFF standard is under development. A draft specification of this amendment is included in [14], which includes the specifications of the EDRAP sample group and the associated external stream track reference.

The specifications of these two ISOBMFF features are as follows.

### 3.2 Abbreviated Terms

EDRAP extended dependent random access point

### 8.3.3.4 Associated External Stream Track Reference

A track reference of type ‘aest’ (meaning “associated external stream track”) may be included in a video track, referencing an associated video track.

When a video track has a track reference of type ‘aest’, the following applies:
The video track should have at least one sample that contains an EDRAP picture.
For each sample sampleA in the video track containing an EDRAP picture, there shall be one and only one sample sampleB in the associated video track that has the same decoding time as sampleA, and a number of consecutive samples in the associated video track, starting from sampleB, shall exclusively contain all the pictures, not contained in the video track that contains sampleA and that are needed when random accessing from the EDRAP picture contained in sampleA.

Every sample in the referenced track shall be identified as a sync sample. The referenced track header flags shall have track_in_movie and track_in_preview both set to 0.

A restricted scheme shall be used for each referenced track, as follows:
1) At least one sample entry type of each sample entry of the track shall be equal to ‘resv’.
   Note 1: ‘resv’ does not have to be the sample entry type of a SampleEntry directly contained in SampleDescriptionBox when the track has undergone several transformations.
2) The untransformed sample entry type is stored within an OriginalFormatBox contained in the RestrictedScheme InfoBox.
3) The scheme_type field in the SchemeTypeBox, which is in the RestrictedSchemeInfoBox, is equal to ‘aest’, indicating that a sample in the track may contain more than one coded picture.
4) Bit 0 of the flags field of the SchemeTypeBox is equal to 0, such that the value of (flags & 0x000001) is equal to 0.

### 10.11 Extended DRAP (EDRAP) Sample Group

### 10.11.1 Definition

This sample group is similar to the DRAP sample group as specified in subclause 10.8; however, it enables more flexible cross-RAP referencing.

An EDRAP sample is a sample after which all samples in decoding order and in output order can be correctly decoded if the closest SAP sample of type 1, 2, or 3 preceding the EDRAP sample and zero or more other identified EDRAP samples earlier in decoding order than the EDRAP sample are available for reference.

NOTE: Similarly as for DRAP samples, EDRAP samples can only be used in combination with SAP samples of type 1, 2 and 3.

### 10.11.2 Syntax

```
class VisualEdrapEntry( )
extends VisualSampleGroupEntry(‘edrp’) {
  unsigned int(3) edrap_type;
  unsigned int(3) num_ref_edrap_pics;
  unsigned int(26) reserved = 0;
  for(i=0; i<num_ref_edrap_pics; i++)
    unsigned int(16) ref_edrap_idx_delta[i];
}
```

### 10.11.3 Semantics

edrap_type is a non-negative integer. When edrap_type is in the range of 1 to 3 it indicates the SAP_type (as specified in Annex I) that the EDRAP sample would have corresponded to, had it not depended on the closest preceding SAP or other EDRAP samples. Other type values are reserved.

num_ref_edrap_pics indicates the number of other EDRAP samples that are earlier in decoding order than the EDRAP sample and are needed for reference to be able to correctly decode the EDRAP sample and all samples following the EDRAP sample in both decoding and output order when starting decoding from the EDRAP sample.

reserved shall be equal to 0. The semantics of this subclause only apply to sample group description entries with reserved equal to 0. Parsers shall allow and ignore sample group description entries with reserved greater than 0 when parsing this sample group.

ref_edrap_idx_delta[i] indicates the difference between the sample group index (i.e., the index to the list of all samples in this sample group in decoding order) of this EDRAP sample and the sample group index of the i-th RAP sample that is earlier in decoding order than the EDRAP sample and is needed for reference to be able to correctly decode the EDRAP sample and all samples following the EDRAP sample in both decoding and output order when starting decoding from this EDRAP sample. The value 1 indicates that the i-th RAP sample is the latest RAP sample in the sample group and preceding this EDRAP sample in decoding order, the value 2 indicates that the i-th RAP sample is the second latest RAP sample in the sample group and preceding this EDRAP sample in decoding order, and so on.

### 2.5.4 the MSR and ESR Descriptors

An amendment to the DASH standard is under development. A draft specification of this amendment is included in [15], which includes the specification of the MSR and ESR descriptors for support of EDRAP based video streaming in DASH.

The specification of the MSR and ESR descriptors are as follows.

### 3.2 Abbreviated Terms

EDRAP extended dependent random access point
ESR external stream Representation
MSR main stream Representation

### 5.8.5.15 MSR and ESR Descriptors

### 5.8.5.15.1 General

An Adaptation Set may have an EssentialProperty descriptor with @schemeIdUri equal to urn:mpeg:dash:msr:2021. This descriptor is referred to as the MSR descriptor. The presence of an MSR descriptor in an Adaptation Set indicates that each Representation in the Adaptation Set is an MSR, which carries a main stream track (MST) specified in ISO/IEC 14496 12:2021 AMD1.

An Adaptation Set may have an EssentialProperty descriptor with @schemeldUri equal to urn:mpeg:dash:esr:2021. This descriptor is referred to as the ESR descriptor. The presence of an ESR descriptor in an Adaptation Set indicates that each Representation in the Adaptation Set is an ESR, which carries an external stream track (EST) specified in ISO/IEC 14496 12:2021 AMD1. An ESR shall only be consumed or played back together with its associated MSR.

Each ESR shall be associated with an MSR through the Representation-level attributes @associationId and @associationType in the MSR as follows: the @id of the associated ESR shall be referred to by a value contained in the attribute @associationId for which the corresponding value in the attribute @associationType is equal to ‘aest’. Each MSR shall have an associated ESR.

For an MSR and an ESR associated with each other, the following applies:
For each media sample with a particular presentation time in the ESR, there shall be a corresponding media sample with the same presentation time in the MSR.
Each media sample in the MSR that has a corresponding ESR media sample is referred to as an EDRAP sample.
The first byte position of each EDRAP sample in the MSR is the starting access unit index (I_{SAU}) of a SAP, which enables playback of the media stream in the MSR provided that the corresponding ESR media sample is provided to the media decoder immediately before the EDRAP sample and the subsequent samples in the MSR.
Each EDRAP sample in the MSR shall be the first sample in a Segment (i.e., each EDRAP sample shall start a Segment).
For each Segment in the MSR that starts with an EDRAP sample, there shall be a Segment in the ESR having the same Segment start time as the MSR Segment.
The concatenation of any Segment in the ESR and the corresponding Segment and all subsequent Segments in the MSR shall result in a conforming bitstream.
For each MSR Segment that does not start with an EDRAP sample, there shall be no corresponding Segment in the ESR having the same Segment start time as the MSR Segment.

### 5.8.5.15.2 Example Content Preparation and Client Operations (Informative)

Below are example content preparation and client operations based on MSRs and their associated ESRs.

An example of content preparation operations is as follows:
1) A video content is encoded into one or more representations, each is of a particular spatial resolution, temporal resolution, and quality.
2) Each representation of the video content is represented by a pair of MSR and ESR associated with each other.
3) The MSRs of the video content are included in one Adaptation Set. The ESRs of the video content are included in another Adaptation Set.

An example of client operations is as follows:
1) A client gets the MPD of the Media Presentation, parses the MPD, selects an MSR, and determines the starting presentation time from which the content is to be consumed.
2) The client requests Segments of the MSR, starting from the Segment containing the sample having presentation time equal to (or close enough to) the determined starting presentation time.
   a. If the first sample in the starting Segment is an EDRAP sample, the corresponding Segment (having the same Segment start time) in the associated ESR is also requested, preferably before requesting of the MSR Segments. Otherwise, no Segment of the associated ESR is requested.
3) When switching to a different MSR, the client requests Segments of the switch-to MSR, starting from the first Segment having Segment start time greater than that of the last requested Segment of the switch-from MSR.
   a. If the first sample in the starting Segment in the switch-to MSR is an EDRAP sample, the corresponding Segment in the associated ESR is also requested, preferably before requesting of the MSR Segments. Otherwise, no Segment of the associated ESR is requested.
4) When continuously operating at the same MSR (after decoding of the starting Segment after a seeking or stream switching operation), no Segment of the associated ESR needs to be requested, including when requesting any subsequent Segment starting with an EDRAP sample.

### 3. TECHNICAL PROBLEMS SOLVED BY DISCLOSED TECHNICAL SOLUTIONS

EDRAP based video streaming is supported in DASH through the specification of the MSRs and ESRs. However, the following problems exist:
1) It is specified that each EDRAP sample in an MSR shall be the first sample in a Segment (i.e., each EDRAP sample shall start a Segment). Consequently, it is disallowed for an EDRAP sample in an MSR not to start a Segment, and Subsegments based EDRAP streaming is not supported, and configurations such as Segments start with IRAP samples while Subsegments start with EDRAP samples are disallowed. Given the lengths of Segments, Subsegments based streaming operations allow for controlling the streaming process in a finer granularity through requesting media data in a finer granularity.
2) When an EDRAP sample in an MSR is allowed not to start a Segment and when it starts a Subsegment that is not the first Subsegment in a Segment, there lacks a requirement that requires the presence of a corresponding Segment or Subsegment in the associated ESR.
3) When an EDRAP sample in an MSR is allowed not to start a Segment, there lacks a requirement that requires that the concatenation of any Segment in an ESR and the corresponding MSR Segment or Subsegment and all subsequent MSR Segments or Subsegments shall result in a conforming bitstream.
4) When an EDRAP sample in an MSR is allowed not to start a Segment, there lacks a requirement that requires that for each MSR Segment or Subsegment that does not start with an EDRAP sample, there shall be no corresponding ESR Segment having the same earliest presentation time as the MSR Segment or Subsegment.
5) When an EDRAP sample in an MSR is allowed not to start a Segment, there lacks example streaming operations based on Subsegments that start with an EDRAP sample.

### 5. A LISTING OF SOLUTIONS AND EMBODIMENTS

Disclosed herein is a mechanism to allow EDRAP to support various video streaming functions without creating errors. As noted above, the EDRAP pictures are access points into a bitstream. EDRAP pictures can be transmitted using less data than IRAP pictures, but EDRAP pictures are dependent on IRAP pictures (e.g. IDR pictures) and/or other EDRAP pictures in an external bitstream. Accordingly, a portion of a main bitstream that begins with an EDRAP picture can only be decoded if the corresponding IRAP and/or EDRAP pictures have been obtained from the external bitstream. The present disclosure allows both segments and subsegments of a main bitstream to be initialized by EDRAP pictures by ensuring that corresponding IRAP and/or EDRAP pictures within the external bitstream are present with a same earliest presentation time. In this way, the segments and/or subsegments in the main bitstream are guaranteed to be decodable. As such, adding these requirements ensures that a bitstream conforms to standards, is always decodable, and supports streaming from both segments and subsegments in the main bitstream. Further, errors are avoided by requiring that any main bitstream EDRAP and corresponding external bitstream pictures can be concatenated together with later EDRAP pictures in the main bitstream while still being completely decodable (e.g., resulting in a conforming bitstream). To support simplicity, the external bitstream only includes pictures at presentation times that correspond with EDRAP pictures in the main bitstream. When there is no EDRAP picture at a presentation time in the main bitstream, there should be no corresponding pictures at the same presentation time in the external bitstream. Specific mechanisms for using the main bitstream and the external bitstream to stream from both segments and subsegments are also disclosed, for example from a client perspective. The following describes various solutions to these and other issues as noted above.

To solve the above-described problem, methods as summarized below are disclosed. The aspects should be considered as examples to explain the general concepts and should not be interpreted in a narrow way. Furthermore, these examples can be applied individually or combined in any manner.
1) To solve the first problem, it is allowed for an EDRAP sample in an MSR not to start a Segment.
   a. In one example, it is specified that each EDRAP sample in an MSR shall be the first sample in a Segment or Subsegment (i.e., each EDRAP sample shall start a Segment or Subsegment).
2) To solve the second problem, it is specified that, for each Segment or Subsegment in an MSR that starts with an EDRAP sample, there shall be a Segment in the associated ESR having the same earliest presentation time as the MSR Segment or Subsegment.
   a. In one example, additionally, it is specified that ESRs only have Segments and no Subsegments, and each sample in an ESR is in its own Segment.
   b. Alternatively, it is allowed for ESRs to have Subsegments, and it is specified that for each Segment or Subsegment in an MSR that starts with an EDRAP sample, there shall be a Segment or Subsegment in the associated ESR having the same earliest presentation time as the MSR Segment or Subsegment.
3) To solve the third problem, it is specified that, the concatenation of any Segment in an ESR and the corresponding MSR Segment or Subsegment (i.e., the Segment or Subsegment that is in the associated MSR and has the same earliest presentation time as the ESR Segment) and all subsequent MSR Segments or Subsegments shall result in a conforming bitstream.
4) To solve the fourth problem, it is specified that, for each MSR Segment or Subsegment that does not start with an EDRAP sample, there shall be no corresponding ESR Segment having the same earliest presentation time as the MSR Segment or Subsegment.
5) To solve the fifth problem, one or more of the following example streaming operations are specified:
   a. A client gets the MPD of the Media Presentation, parses the MPD, selects an MSR.
   b. When initializing a session or performing seeking, the client determines the starting presentation time from which the content is to be consumed, requests Segments or Subsegments of the MSR, starting from the Segment or Subsegment starting with a SAP and containing the sample having presentation time equal to (or earlier than but close enough to) the determined starting presentation time. For requesting Subsegments in a Segment, a Segment Index is requested beforehand to obtain information of the Subsegments and partial HTTP GET requests are used.
      i. If in the associated ESR there is a Segment having the same earliest presentation time as the starting MSR Segment or Subsegment, that ESR Segment is also requested, preferably before requesting of the starting MSR Segment or Subsegment. Otherwise, no Segment of the associated ESR is requested.
   c. When switching to a different MSR, the client requests Segments or Subsegments of the switch-to MSR, starting from the first Segment or Subsegment having earliest presentation time greater than that of the last requested Segment or Subsegment of the switch-from MSR.
      i. If in the associated ESR there is a Segment having the same earliest presentation time as the starting Segment or Subsegment in the switch-to MSR, that ESR Segment is also requested, preferably before requesting of the starting Segment or Subsegment in the switch-to MSR. Otherwise, no Segment of the associated ESR is requested.
   d. When continuously requesting and consuming subsequent Segments or Subsegments of an MSR after session initialization, seeking, or stream switching, no Segment of the associated ESR needs to be requested, including when requesting any subsequent MSR Segment or Subsegment starting with an EDRAP sample.

### 6. EMBODIMENTS

Below are some example embodiments for all the disclosure items and most of their subitems summarized above in Section 4. These embodiments can be applied to DASH. The changes are marked relative to the text of the design in Subsection 2.4.4. Most relevant parts that have been added or modified are shown in bold font, and some of the deleted parts are shown in italicized bold fonts. There may be some other changes that are editorial in nature and thus not highlighted.

### 3.2 Abbreviated Terms

EDRAP extended dependent random access point
ESR external stream Representation
MSR main stream Representation
   5.8.5.15 MSR and ESR descriptors

### 5.8.5.15.1 General

An Adaptation Set may have an EssentialProperty descriptor with @schemeldUri equal to urn:mpeg:dash:msr:2022. This descriptor is referred to as the MSR descriptor. The presence of an MSR descriptor in an Adaptation Set indicates that each Representation in the Adaptation Set is an MSR, which carries a video track having a track reference of type ‘aest’ as specified in ISO/IEC 14496 12:2021 AMD1.

An Adaptation Set may have an EssentialProperty descriptor with @schemeldUri equal to urn:mpeg:dash:esr:2022. This descriptor is referred to as the ESR descriptor. The presence of an ESR descriptor in an Adaptation Set indicates that each Representation in the Adaptation Set is an ESR, which carries a video track referenced by a track reference of type ‘aest’ as specified in ISO/IEC 14496 12:2021 AMD1. An ESR shall only be consumed or played back together with its associated MSR.

Each ESR shall be associated with an MSR through the Representation-level attributes @associationId and @associationType in the MSR as follows: the @id of the associated ESR shall be referred to by a value contained in the attribute @associationId for which the corresponding value in the attribute @associationType is equal to ‘aest’. Each MSR shall have an associated ESR. For an MSR and an ESR associated with each other, the following applies:
For each media sample with a particular presentation time in the ESR, there shall be a corresponding media sample with the same presentation time in the MSR.
Each media sample in the MSR that has a corresponding ESR media sample is referred to as an EDRAP sample.
The first byte position of each EDRAP sample in the MSR is the I_{SAU} of a SAP, which enables playback of the media stream in the MSR provided that the corresponding ESR media sample is provided to the media decoder immediately before the EDRAP sample and the subsequent samples in the MSR.
Each EDRAP sample in the MSR shall be the first sample in a Segment or Subsegment (i.e., each EDRAP sample shall start a Segment or Subsegment).
For each Segment or Subsegment in the MSR that starts with an EDRAP sample, there shall be a Segment in the ESR having the same earliest presentation time as the MSR Segment or Subsegment.
The concatenation of any Segment in the ESR and the corresponding MSR Segment or Subsegment (i.e., the MSR Segment or Subsegment having the same earliest presentation time as the ESR Segment) and all subsequent MSR Segments or Subsegments shall result in a conforming bitstream.
For each MSR Segment or Subsegment that does not start with an EDRAP sample, there shall be no corresponding ESR Segment having the same earliest presentation time as the MSR Segment or Subsegment.

### 5.8.5.15.2 Example Content Preparation and Client Operations (Informative)

Below are example content preparation and client operations based on MSRs and their associated ESRs.

An example of content preparation operations is as follows:
1) A video content is encoded into one or more representations, each of which is of a particular spatial resolution, temporal resolution, and quality.
2) Each representation of the video content is represented by a pair of MSR and ESR associated with each other.
3) The MSRs of the video content are included in one Adaptation Set. The ESRs of the video content are included in another Adaptation Set.

An example of client operations is as follows:
1) A client gets the MPD of the Media Presentation, parses the MPD, selects an MSR.
2) When initializing a session or performing seeking, the client determines the starting presentation time from which the content is to be consumed, requests Segments or Subsegments of the MSR, starting from the Segment or Subsegment starting with a SAP and containing the sample having presentation time equal to (or earlier than but close enough to) the determined starting presentation time. For requesting Subsegments in a Segment, a Segment Index is requested beforehand to obtain information of the Subsegments and partial HTTP GET requests are used.
   a. If in the associated ESR there is a Segment having the same earliest presentation time as the starting MSR Segment or Subsegment, that ESR Segment is also requested, preferably before requesting of the starting MSR Segment or Subsegment. Otherwise, no Segment of the associated ESR is requested.
3) When switching to a different MSR, the client requests Segments or Subsegments of the switch-to MSR, starting from the first Segment or Subsegment having earliest presentation time greater than that of the last requested Segment or Subsegment of the switch-from MSR.
   a. If in the associated ESR there is a Segment having the same earliest presentation time as the starting Segment or Subsegment in the switch-to MSR, that ESR Segment is also requested, preferably before requesting of the starting Segment or Subsegment in the switch-to MSR. Otherwise, no Segment of the associated ESR is requested.
4) When continuously requesting and consuming subsequent Segments or Subsegments of an MSR after session initialization, seeking, or stream switching, no Segment of the associated ESR needs to be requested, including when requesting any subsequent MSR Segment or Subsegment starting with an EDRAP sample.

### 7. REFERENCES

[1] ITU-T and ISO/IEC, “High efficiency video coding”, Rec. ITU-T H.265|ISO/IEC 23008-2 (in force edition).
[2] J. Chen, E. Alshina, G. J. Sullivan, J.-R. Ohm, J. Boyce, “Algorithm description of Joint Exploration Test Model 7 (JEM7),” JVET-G1001, August 2017.
[3] Rcc. ITU-T H.266|ISO/IEC 23090-3, “Versatile Video Coding”, 2020.
[4] B. Bross, J. Chen, S. Liu, Y.-K. Wang (editors), “Versatile Video Coding (Draft 10),” JVET-S2001.
[5] Rec. ITU-T Rec. H.274|ISO/IEC 23002-7, “Versatile Supplemental Enhancement Information Messages for Coded Video Bitstreams”, 2020.
[6] J. Boyce, V. Drugcon, G. J. Sullivan, Y.-K. Wang (editors), “Versatile supplemental enhancement information messages for coded video bitstreams (Draft 5),” JVET-S2007.
[7] ISO/IEC 14496-12: “Information technology—Coding of audio-visual objects—Part 12: ISO base media file format”.
[8] ISO/IEC 23009-1: “Information technology—Dynamic adaptive streaming over HTTP (DASH)—Part 1: Media presentation description and segment formats”. The 4th edition text of the DASH standard specification can be found in MPEG input document m52458.
[9] ISO/IEC 14496-15: “Information technology—Coding of audio-visual objects—Part 15: Carriage of network abstraction layer (NAL) unit structured video in the ISO base media file format”.
[10] ISO/IEC 23008-12: “Information technology—High efficiency coding and media delivery in heterogeneous environments—Part 12: Image File Format”.
[11] ISO/IEC JTC 1/SC 29/WG 03 output document N0035, “Potential improvements on Carriage of VVC and EVC in ISOBMFF”, November 2020.
[12] ISO/IEC JTC 1/SC 29/WG 03 output document N0038, “Information technology—High efficiency coding and media delivery in heterogeneous environments-Part 12: Image File Format—Amendment 3: Support for VVC, EVC, slideshows and other improvements (CD stage)”, November 2020.
[13] J. Boyce, G. J. Sullivan, Y.-K. Wang (editors), “Additional SEI messages for VSEI (Draft 6),” JVET-Y2006.
[14] ISO/IEC JTC 1/SC 29/WG 03 output document N0471, “Text of CDAM ISO/IEC 14496-12:2021 AMD 1 Improved brand documentation and other improvements”, February 2022.
[15] ISO/IEC JTC 1/SC 29/WG 03 output document N0486, “WD of ISO/IEC 23009-15th edition AMD2 EDRAP streaming and other extensions”, January 2022.

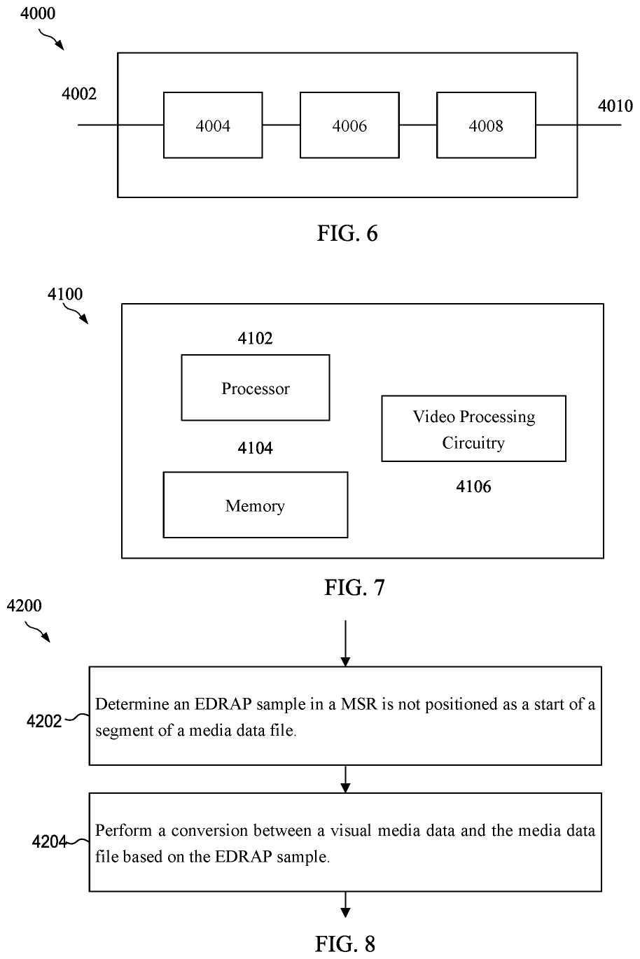

FIG. 6 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present document. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present document may be embodied in various electronic devices such as mobile phones, laptops, smartphones or other devices that are capable of performing digital data processing and/or video display.

FIG. 7 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present document. The memory (memories) 4104 may be used for storing data and code used for implementing the methods and techniques described herein. The video processing circuitry 4106 may be used to implement, in hardware circuitry, some techniques described in the present document. In some embodiments, the video processing circuitry 4106 may be at least partly included in the processor 4102, e.g., a graphics co-processor.

FIG. 8 is a flowchart for an example method 4200 of video processing. The method 4200 includes an EDRAP sample in a MSR is not positioned as a start of a segment of a media data file at step 4202. A conversion is performed between a visual media data and the media data file based on the EDRAP sample at step 4204.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

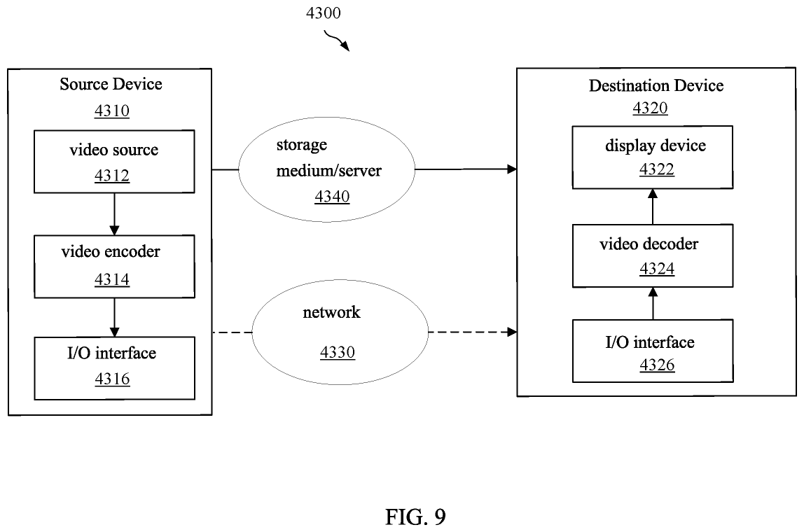

FIG. 9 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

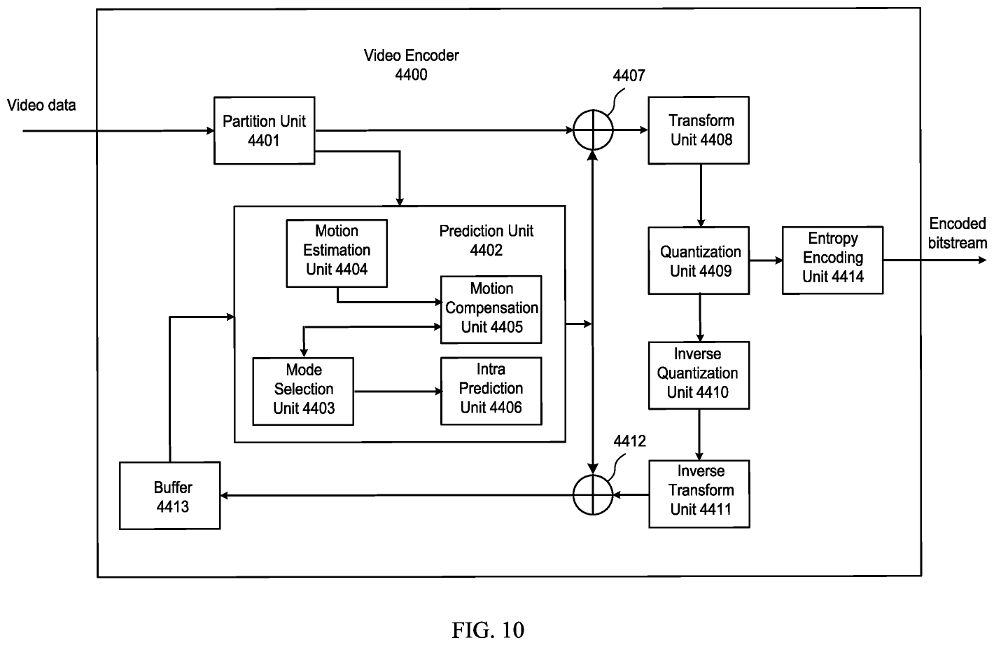

FIG. 10 is a block diagram illustrating an example of video encoder 4400, which may be video encoder 4314 in the system 4300 illustrated in FIG. 9. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode selection unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

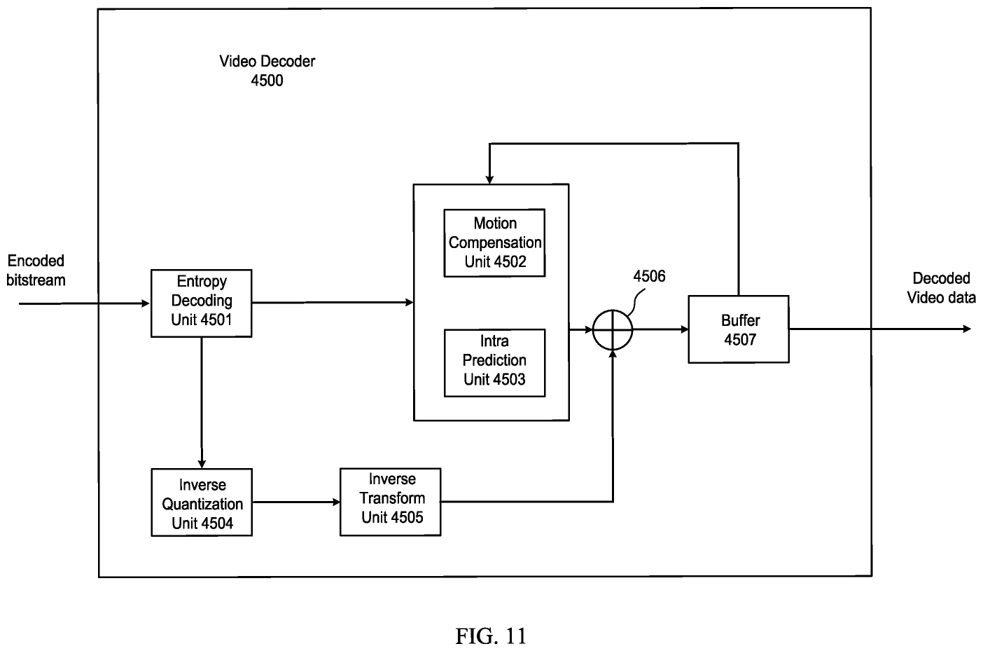

FIG. 11 is a block diagram illustrating an example of video decoder 4500 which may be video decoder 4324 in the system 4300 illustrated in FIG. 9. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

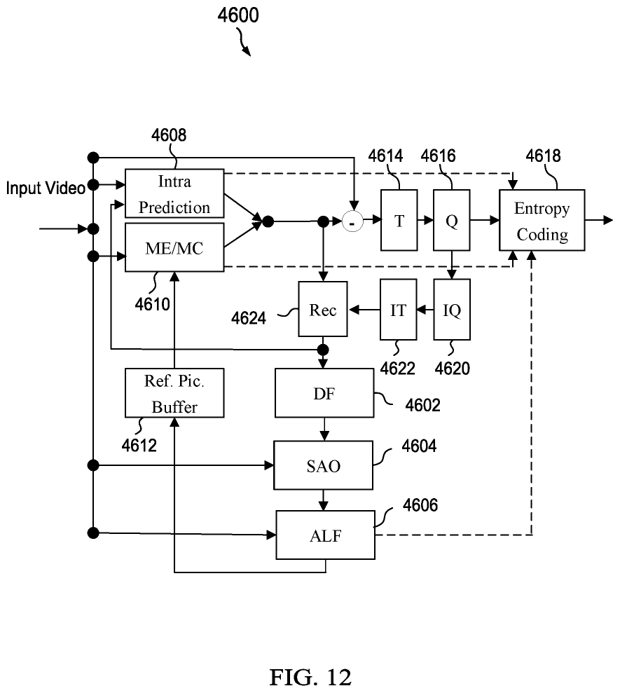

FIG. 12 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/motion compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

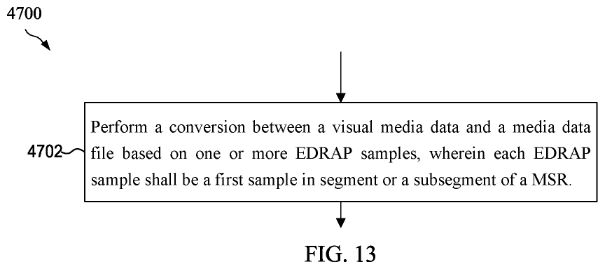

FIG. 13 is a flowchart for an example method 4700 of video processing. A conversion is performed between a visual media data and the media data file based on one or more EDRAP samples at step 4702. Each EDRAP sample shall be a first sample in segment or a subsegment of a MSR. For example, each EDRAP sample is required to be a first sample in segment or a subsegment of an MSR to result in a conforming bitstream. For example, one of the EDRAP samples may start the segment, one of the EDRAP samples may start the subsegment, or both.

In some examples, for each segment or subsegment in the MSR that starts with one of the EDRAP samples, an external stream representation (ESR) segment shall have a same earliest presentation time as the segment or subsegment in the MSR. For example, the conversion at step 4702 may comprise a concatenation of an ESR segment and the segment or subsegment in the MSR and all subsequent MSR segments or subsegments, which results in a conforming bitstream. In some examples, for each MSR segment or subsegment that does not start with an EDRAP sample, there is no corresponding ESR segment having a same earliest presentation time as the each MSR segment or subsegment.

In some examples, the method 4700 is performed as part of a client operation on a client. In such examples, the client may obtain a MPD of a media presentation, parse the MPD, and select an MSR as part of the conversion at step 4702.

In some examples, the conversion at step 4702 includes initializing a session or performing seeking. In some examples, when initializing a session or performing seeking, the client determines a starting presentation time from which content is to be consumed and requests segments or subsegments of the MSR starting from a segment or subsegment starting with a SAP and containing a sample having a presentation time equal the determined starting presentation time. In some examples, for requesting subsegments in a segment, a segment index is requested to obtain information of subsegments, and wherein partial HTTP GET requests are used.

In some examples, when there is an ESR segment having a same earliest presentation time as a starting MSR segment or subsegment, the ESR segment is also requested before requesting the starting MSR segment or subsegment. In some examples, when there is no ESR segment having a same earliest presentation time as a starting MSR segment or subsegment, no segment of the ESR is requested.

In some examples, when switching to a switch-to MSR, the client requests segments or subsegments of the switch-to MSR starting from a first segment or subsegment having an earliest presentation time greater than that of a last requested segment or subsegment of a switch-from MSR. For example, when there is an ESR segment having a same earliest presentation time as a starting segment or subsegment in a switch-to MSR, the ESR segment is also requested before requesting the starting segment or subsegment in the switch-to MSR. Further, when there is no ESR segment having a same earliest presentation time as a starting segment or subsegment in a switch-to MSR, no ESR segment is requested.

In some examples, when seeking, stream switching, or continuously requesting and consuming subsequent segments or subsegments of an MSR after session initialization, no ESR segment is requested including when requesting any subsequent MSR segment or subsegment starting with an EDRAP sample.

In some examples, performing a conversion between a visual media data and the media data file at step 4702 comprises encoding the visual media data into a bitstream. In some examples, performing a conversion between a visual media data and the media data file at step 4702 comprises decoding the visual media data from a bitstream.

It should be noted that the method 4700 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4700. Further, the method 4700 can be performed by a non-transitory computer readable medium comprising a computer program product for use by a video coding device. The computer program product comprises computer executable instructions stored on the non-transitory computer readable medium such that when executed by a processor cause the video coding device to perform the method 4700.

A listing of solutions preferred by some examples is provided next.

The following solutions show examples of techniques discussed herein.

The following solutions show example embodiments of techniques discussed in the previous section (e.g., item 1).

1. A method for processing video data (e.g., method 4200 depicted in FIG. 8) comprising: determining (4202) an extended dependent random access point (EDRAP) sample in a main stream representation (MSR) is not positioned as a start of a segment of a media data file; and performing (4204) a conversion between a visual media data and the media data file based on the EDRAP sample.

2. The method of solution 1, wherein the EDRAP sample is a first sample in a subsegment of the media data file.

The following solutions show example embodiments of techniques discussed in the previous section (e.g., item 2).

3. A method for processing video data comprising: determining, that for each segment or subsegment in an main stream representation (MSR) that starts with an extended dependent random access point (EDRAP) sample, a segment in an associated external stream representation (ESR) has a same earliest presentation time as the segment or subsegment in the MSR; and performing a conversion between a visual media data and the media data file based on the EDRAP sample.

4. The method of solution 3, wherein the ESR only has segments and no subsegments, and wherein each sample in the ESR has a corresponding segment.

5. The method of solution 3, wherein the ESR has subsegments, wherein for each segment of subsegment in the MSR that starts with an EDRAP sample, a segment or subsegment in the ESR has a same earliest presentation time as the segment or subsegment in the MSR.

The following solutions show example embodiments of techniques discussed in the previous section (e.g., item 3).

6. A method for processing video data comprising: determining that a concatenation of any segment in an external stream representation (ESR) and a corresponding main stream representation (MSR) segment or corresponding MSR subsegment and all subsequent MSR segments or MSR subsegments shall result in a conforming bitstream; and performing a conversion between a visual media data and the media data file based on the ESR and MSR segments or MSR subsegments.

The following solutions show example embodiments of techniques discussed in the previous section (e.g., item 4).

7. A method for processing video data comprising: determining that for each main stream representation (MSR) segment or subsegment that does not start with an EDRAP sample, there shall be no corresponding external stream representation (ESR) segment having a same earliest presentation time as the MSR segment or subsegment; and performing a conversion between a visual media data and the media data file based on the ESR segment and MSR segment or subsegment.

The following solutions show example embodiments of techniques discussed in the previous section (e.g., item 5).

8. A method for processing video data comprising: determining a starting presentation time; obtaining a main stream representation (MSR) segment or subsegment having a presentation time equal to the starting presentation time; obtaining an external stream representation (ESR) segment having a same presentation time as the MSR segment or subsegment; and performing a conversion between a visual media data and the media data file based on the ESR segment and MSR segment or subsegment.

9. The method of solution 8, further comprising selecting the MSR from an MPD.

10. The method of any of solutions 8-9, further comprising: switching to a switch to MSR segment or subsegment at a switching presentation time; and obtaining an ESR segment with having a same switching presentation time as the MSR segment or subsegment.

11. The method of any of solutions 8-10, wherein no ESR segment is requested when continuously consuming MSR segments or subsegments after session initialization, seeking, or stream switching.

12. An apparatus for processing video data comprising: a processor; and a non-transitory memory with instructions thereon, wherein the instructions upon execution by the processor, cause the processor to perform the method of any of solutions 1-11.

13. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-11.

14. A method, apparatus or system described in the present document.

The following solutions show further examples of techniques discussed herein.

1. A method for processing video data comprising: performing a conversion between a visual media data and a media data file based on one or more extended dependent random access point (EDRAP) samples, wherein each EDRAP sample shall be a first sample in segment or a subsegment of a main stream representation (MSR).

2. The method of solution 1, wherein one of the EDRAP samples is allowed to start the segment.

3. The method of any of solutions 1-2, wherein one of the EDRAP samples is allowed to start the subsegment and not to start the segment.

4. The method of any of solutions 1-3, wherein for each segment or subsegment in the MSR that starts with one of the EDRAP samples, there is a segment in an external stream representation (ESR) with a same earliest presentation time as the segment or subsegment in the MSR.

5. The method of any of solutions 1-4, wherein the conversion comprises a concatenation of an ESR segment and corresponding segment or subsegment in the MSR and all subsequent MSR segments or subsegments resulting in a conforming bitstream.

6. The method of solution 5, wherein the corresponding segment or subsegment in the MSR has a same earliest presentation time as the ESR Segment.

7. The method of any of solutions 1-6, wherein for each MSR segment or subsegment that does not start with an EDRAP sample, there is no corresponding ESR segment having a same earliest presentation time as the each MSR segment or subsegment.

8. The method of any of solutions 1-7, wherein the method is performed as part of a client operation on a client.

9. The method of any of solution 8, wherein the client obtains a media presentation description (MPD) of a media presentation, parses the MPD, and selects an MSR.

10. The method of any of solutions 1-9, wherein when initializing a session or performing seeking, the client determines a starting presentation time from which content is to be consumed and requests segments or subsegments of the MSR starting from a segment or subsegment starting with a stream access point (SAP) and containing a sample having a presentation time equal to the determined starting presentation time.

11. The method of any of solutions 1-10, wherein for requesting subsegments in a segment, a segment index is requested to obtain information of subsegments, and wherein partial Hypertext Transfer Protocol (HTTP) GET requests are used.

12. The method of any of solutions 1-11, wherein when there is an ESR segment having a same earliest presentation time as a starting MSR segment or subsegment, the ESR segment is also requested before requesting the starting MSR segment or subsegment.

13. The method of any of solutions 1-12, wherein when there is no ESR segment having a same earliest presentation time as a starting MSR segment or subsegment, no segment of the ESR is requested.

14. The method of any of solutions 1-13, wherein when switching to a switch-to MSR, the client requests segments or subsegments of the switch-to MSR starting from a first segment or subsegment having an earliest presentation time greater than that of a last requested segment or subsegment of a switch-from MSR.

15. The method of any of solutions 1-14, wherein when there is an ESR segment having a same earliest presentation time as a starting segment or subsegment in a switch-to MSR, the ESR segment is also requested before requesting the starting segment or subsegment in the switch-to MSR.

16. The method of any of solutions 1-15, wherein when there is no ESR segment having a same earliest presentation time as a starting segment or subsegment in a switch-to MSR, no ESR segment is requested.

17. The method of any of solutions 1-16, wherein when seeking, stream switching, or continuously requesting and consuming subsequent segments or subsegments of an MSR after session initialization, no ESR segment is requested including when requesting any subsequent MSR segment or subsegment starting with an EDRAP sample.

18. The method of any of solutions 1-17, wherein performing a conversion between a visual media data and the media data file comprises encoding the visual media data into the media data file.

19. The method of any of solutions 1-17, performing a conversion between a visual media data and the media data file comprises decoding the visual media data from the media data file.

20. An apparatus for processing video data comprising: a processor; and a non-transitory memory with instructions thereon, wherein the instructions upon execution by the processor, cause the processor to perform the method of any of solutions 1-19.

21. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-19.

22. A non-transitory computer-readable recording medium storing a bitstream of a video which is generated by a method performed by a video processing apparatus, wherein the method comprises: determining to perform a conversion between a visual media data and a media data file based on one or more extended dependent random access point (EDRAP) samples, wherein each EDRAP sample shall be a first sample in segment or a subsegment of a main stream representation (MSR); and generating a bitstream based on the determining.

23. A method for storing bitstream of a video comprising: determining to perform a conversion between a visual media data and a media data file based on one or more extended dependent random access point (EDRAP) samples, wherein each EDRAP sample shall be a first sample in segment or a subsegment of a main stream representation (MSR); generating a bitstream based on the determining; and storing the bitstream in a non-transitory computer-readable recording medium.

24. A method, apparatus or system described in the present document.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present document, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing video data comprising:
performing a conversion between visual media data and a media data file based on one or more extended dependent random access point (EDRAP) samples according to a first rule, and
wherein the first rule specifies that each EDRAP sample in a main stream representation (MSR) shall be a first sample in a segment or a subsegment.

2. The method of claim 1, wherein the first rule further specifies that for each segment or subsegment in the MSR that starts with an EDRAP sample, there is a segment in an external stream representation (ESR) having a same earliest presentation time as the segment or subsegment in the MSR.

3. The method of claim 1, wherein the first rule further specifies that a concatenation of an external stream representation (ESR) segment and a corresponding MSR segment or subsegment and all subsequent MSR segments or subsegments results in a conforming bitstream.

4. The method of claim 3, wherein the corresponding MSR segment or subsegment has a same earliest presentation time as the ESR Segment.

5. The method of claim 1, wherein the first rule further specifies that for each MSR segment or subsegment that does not start with an EDRAP sample, there is no corresponding external stream representation (ESR) segment having a same earliest presentation time as the MSR segment or subsegment.

6. The method of claim 1, wherein client operations based on the MSR and an external stream representation (ESR) associated with the MSR are performed by a client according to a second rule; and
wherein the second rule specifies that the client obtains a media presentation description (MPD) of a media presentation, parses the MPD, and selects an MSR.

7. The method of claim 6, wherein the second rule further specifies that when initializing a session or performing seeking, the client determines a starting presentation time from which content is to be consumed, and requests segments or subsegments of the MSR, starting from a segment or subsegment starting with a stream access point (SAP) and containing a sample having a presentation time equal to the determined starting presentation time.

8. The method of claim 7, wherein for requesting subsegments in a segment, a segment index is requested to obtain information of subsegments, and wherein partial Hypertext Transfer Protocol (HTTP) GET requests are used.

9. The method of claim 6, wherein the second rule further specifies that, when in the associated ESR, there is an ESR segment having a same earliest presentation time as a starting MSR segment or subsegment, the ESR segment is requested.

10. The method of claim 6, wherein the second rule further specifies that, when in the associated ESR, there is no ESR segment having a same earliest presentation time as a starting MSR segment or subsegment, no segment of the associated ESR is requested.

11. The method of claim 6, wherein the second rule further specifies that, when switching to a switch-to MSR, the client requests segments or subsegments of the switch-to MSR, starting from a first segment or subsegment having an earliest presentation time greater than an earliest presentation time of a last requested segment or subsegment of a switch-from MSR.

12. The method of claim 11, wherein the second rule further specifies that, when in the associated ESR, there is an ESR segment having a same earliest presentation time as a starting segment or subsegment in the switch-to MSR, the ESR segment is requested.

13. The method of claim 11, wherein the second rule further specifies that, when in the associated ESR, there is no ESR segment having a same earliest presentation time as a starting segment or subsegment in the switch-to MSR, no ESR segment is requested.

14. The method of claim 6, wherein the second rule further specifies that, when continuously requesting and consuming subsequent segments or subsegments of the MSR after session initialization, seeking, or stream switching, no ESR segment of the associated ESR is requested, including when requesting any subsequent MSR segment or subsegment starting with an EDRAP sample.

15. The method of claim 1, wherein the first rule specifies that each EDRAP sample shall start a segment or a subsegment.

16. The method of claim 1, wherein the conversion comprises encoding the visual media data into the media data file.

17. The method of claim 1, wherein the conversion comprises decoding the visual media data from the media data file.

18. An apparatus for processing video data comprising: a processor; and a non-transitory memory with instructions thereon, wherein the instructions upon execution by the processor, cause the processor to:
perform a conversion between visual media data and a media data file based on one or more extended dependent random access point (EDRAP) samples according to a first rule, and
wherein the first rule specifies that each EDRAP sample in a main stream representation (MSR) shall be a first sample in a segment or a subsegment.

19. A non-transitory computer-readable storage medium storing instructions that cause a processor to:
perform a conversion between visual media data and a media data file based on one or more extended dependent random access point (EDRAP) samples according to a first rule, and
wherein the first rule specifies that each EDRAP sample in a main stream representation (MSR) shall be a first sample in a segment or a subsegment.

20. A non-transitory computer-readable recording medium storing a media data file which is generated by a method performed by a video processing apparatus, wherein the method comprises:
generating the media data file for visual media data, based on one or more extended dependent random access point (EDRAP) samples according to a first rule, and
wherein the first rule specifies that each EDRAP sample in a main stream representation (MSR) shall be a first sample in a segment or a subsegment.
